(19) United States
(12) Patent Application Publication
(10) Pub. No.: US 2006/0176031 A1
(43) Pub. Date: Aug. 10, 2006

(54) Dual output switching regulator and method of operation

(75) Inventors: Dustin D. Forman, Kelowna (CA); Andrew Martin Mallinson, Kelowna (CA)

Correspondence Address: STEVENS LAW GROUP, P.O. BOX 1667, SAN JOSE, CA, 95109, US

(73) Assignee: ESS Technology, Inc., Fremont, CA (US)

(21) Appl. No.: 11/238,778

(22) Filed: Sep. 29, 2005

Related U.S. Application Data
(60) Provisional application No. 60/649,954, filed on Feb. 4, 2005.

(51) Int. Cl. G05F 1/577

(52) U.S. Cl. 323/267

(57) ABSTRACT

A system and method of operation of a power switching circuit is provided that includes a charging switch configured to be connected to an inductor at one node and configured to receive control signals to open and close the charging switch. The circuit further includes a first channel coupled to the one node with a first channel switch, configured to supply a first channel voltage, configured to operate in one of buck mode and boost mode and configured to receive control signals to open and close the first channel switch; and a second channel coupled to the one node with a second channel switch, configured to supply a second channel voltage, configured to operate in one of buck mode and boost mode and configured to receive control signals to open and close the first channel switch.

### RELATED APPLICATIONS

This application claims priority based on U.S. Provisional Application No. 60/649,954, filed on Feb. 04, 2005.

### BACKGROUND

The invention relates to a novel switching regulator design that is lower cost and longer batter life in application requiring a dual output (such as MP3 players that require 3.3 and 1.2 supplies).

In the design of inductive switching regulators (i.e. those that to a first order, are loss-less) there are two known topologies commonly called “Boost mode” and “Buck mode”. Buck mode generates an output voltage less than the input voltage and, since loss-less, at a higher current that the input current. Boost mode generates an output voltage higher than the input voltage and therefore necessarily at less current than the input current.

Switching regulators are well known. The known topologies require one inductor for each output voltage. A switching regulator is used when high efficiency is desired, for example, in portable MP3 players. Conventional switching regulators using one inductor for each output voltage also have another limitation. These types of regulators require different topologies for “Buck” or “Boost” modes of operation. Buck mode is when the regulator output voltage is less than the input voltage, and Boost mode is when the output voltage is greater than the input voltage. Getting the conventional topology to switch from one mode to the other (Buck to Boost, or Boost to Buck) is a complicated problem. For example, assume the required output voltage is 2.5V and a battery is driving the input voltage. The battery could be at 3.6V, for example, when it's fully charged, and drop to less than a volt as it is being used. When the battery is at 3.6V the regulator would have to be in a “Buck” mode to get the output to 2.5 Volts. As the battery voltage drops below 2.5 Volts, there is a problem in that the regulator must switch into a “Boost” mode in order to maintain the 2.5Volt output. It should also be able to do this without disturbance to the 2.5 Volts.

Commonly, in the design of a portable device a single cell (ie a single battery) is used to provide for example, 1.5 v as an input and inductive switched mode regulators are used to generate, for example, 3.3 v and 1.2 v—these being the “analog” and the “digital” supply voltages to the chips of the unit. In conventional circuits, in order to make those two voltages, two control loops are required. This is because both outputs must be regulated to their respective target voltages. In conventional systems, this configuration requires two inductors. Also, the provision of 1.2 v is problematic. The battery cell may initially provide 1.5 v, and thus a buck mode is required to generate 1.2 v, since 1.2 v required is less than 1.5 v provided by the battery cell. However, as the battery cell is exhausted, the voltage may drop to 0.9 v. Now, a boost mode is required, since 1.2 v required is now higher than 0.9 v provided by the batter cell. This transition from buck to boost requires a discontinuous configuration change that is impractical. In particular, voltage regulation fails in the range where the input is equal to the output.

One partial solution to the problem of switching between Buck and Boost mode is known: it is sometimes called the “buck-boost” configuration. This known configuration is not useful in many applications because it creates an output voltage that is negative with respect to the input voltage. The disclosed circuit does not suffer from this disadvantage—the output voltages and input voltages are the same sense—commonly both positive.

Conventional switching configurations with output voltages the same sense as input voltages perform either Buck or Boost modes exclusively. And, the only way to switch between the two is to configure switches in the circuit that actually change the way the circuit works. Physically, these switches change the circuit from a Buck to a Boost, or vice versa. This is not a good method, because there results a disruption in operation while reconfiguring the circuit to transition from one mode to the other mode. Within the range of voltage, there exists a point where the output voltage is equal to the input voltage. At this point, the circuit is neither bucking nor boosting the signal, causing a discontinuity in the process. Conventional switching processes do not make this transition smoothly. That is, conventional systems typically have a discontinuous voltage value when switching modes though this transition stage.

All known inductive regulators of either Buck or Boost mode operation use one inductor for each output voltage. For example, to generate 1.2 v from a 1.5 v source an inductor is configured in Buck mode. To also generate a 3.3 v output from the same source a second inductor is configured in Boost mode. One inductor is required for each output voltage in the known art.

Therefore, there exists a need in the art for a practical power switching circuit that can efficiently operate in buck or boost mode, that can switch between modes in a smooth manner and that is inexpensive. Further cost savings are possible if one inductor can create more than one output voltage. As will be seen, the invention accomplishes this in an elegant manner.

### BRIEF DESCRIPTION OF THE DRAWINGS

FIG. 1 is a power switching circuit configured according to the invention;

FIG. 2 is a graph illustrating different phases of the circuit of FIG. 1;

FIGS. 3A-3D illustrate the circuit of FIG. 1 in various phases; and

FIGS. 4A and 4B are graphs illustrating various phases of the circuit of FIG. 1.

### DETAILED DESCRIPTION

The invention is directed to a new switching regulator design that is lower cost and longer battery life in an application requiring a dual output. Examples include cellular telephones, MP3 players that require 3.3 and 1.2 supplies, and other portable devices. The dual channel mode lets one channel smoothly transition between the two modes. This transition of the system from one mode to the other is done while one channel remains in boost mode. Whether the system is transitioning from boost to buck, such as when plugging the phone into an outlet or changing the battery, or buck to boost, such as when a battery is losing voltage—in these conditions the circuit performs the transition seamlessly.

Furthermore the circuit is symmetrical, allowing either channel to be in boost mode. In such a circuit, both output channels have similar components. This provides a system where either channel can be in the boost only mode, and the other channel can be in either the buck or boost mode and can switch between the two modes. This allows the circuit to generate a substantially constant voltage using a single inductor. This is in contrast to conventional systems, where dual inductors are required, one for each channel, where each channel is usually in different modes, or in other conventional applications that require tapped inductors configured and adjustable according to the voltage need in a device.

In practical system applications, such as a mobile telephone that requires a substantially constant 1.2 volt power supply, or an MP3 player that needs 3.3 volts, the invention provides a circuit that can generate both 3.3 volts and 1.2 volts from a single battery cell. This can be generated with a battery that, for example, could vary from 0.9 volts to 2.5 volts. According to the invention, this can be done with only one inductor, making it a low cost solution. And only one integrated switching circuit is required. It further enables the smooth switch from buck to boost at the output of the system.

Further advantages are that the invention provides a system having a single input, but providing multiple output voltages using a single inductor. This provides a switching regulator needing only one inductor. In this configuration, no transformer and no taps are required. The invention can provide, for example, a single input circuit having one output capable of operation at 3.3 v, and one output capable of operation at 1.2 v as desirable in the above examples. There are no performance issues as the 1.2 v switches from buck to boost mode which will occur as the input source voltage is decreased from that of a fully charged cell (1.5 v) to that of a almost exhausted cell (0.9 v). Thus, the system can provide a continuous regulated output that can be held above and below input voltage as the power source changes, such as when a battery loses power.

In one embodiment, a power switching circuit includes a charging switch configured to be connected to an inductor at one node and configured to receive control signals to open and close the charging switch. The circuit further includes a first channel coupled to the one node with a first channel switch, configured to supply a first channel voltage, configured to operate in one of buck mode and boost mode and configured to receive control signals to open and close the first channel switch; and a second channel coupled to the one node with a second channel switch, configured to supply a second channel voltage, configured to operate in one of buck mode and boost mode and configured to receive control signals to open and close the first channel switch.

The circuit may further include a controller having a monitoring circuit configured to monitor the value of the output voltage of a voltage source and to transmit control signals to the charging switch, the first channel switch and the second channel switch. The circuit may further include an inductor connected to the one node at one end and connectable to an input voltage source at another end, where the charging switch is connected to a controller at another end and configured to close in response to a controller signal in a charge mode to charge an inductor. And, at least one channel can be configured to supply a voltage value to a controller. The controller can be configured to monitor the voltage levels at either switch to control the charging of an inductor and to switch either the first or second channel switch in buck or boost mode. In a preferred embodiment, at least one channel is in boost mode. The circuit can be configured to supply each channel voltage value to a controller, where controller can send control signals to each of the switches to enable one of the charging of the inductor and delivery of current to at least one channel. The inductor can be configured to receive a charge from a power source in various manners, wherein the first and second channel switches are controlled by a controller configured to supply at least one channel voltage value by closing at least one of the first and second channel switches.

In operation, the method of supplying power with a switching circuit generally includes charging an inductor from a power source and alternately releasing current from the inductor to one load by closing one switch and releasing current from the inductor to another load by closing another switch while substantially simultaneously opening the one switch. Current can be released in an alternate manner, releasing current from the inductor from one switch to another switch, releasing current to at least one switch while current released from the inductor is decreasing. Also, alternately releasing current from the inductor from one switch to another switch occurs in separate phases and includes releasing current during at least one phase while current released from the inductor is decreasing. Also, alternately releasing current from the inductor can be done to one of a plurality of loads by closing a switch associated with one load while any switches associated with other loads are open and releasing current from the inductor to another load by closing another switch while substantially simultaneously opening a previously closed switch. The method can then alternately release current from the inductor via one switch to another switch in separate phases. Again, in a preferred embodiment, the releasing of current is done during at least one phase while current released from the inductor is decreasing.

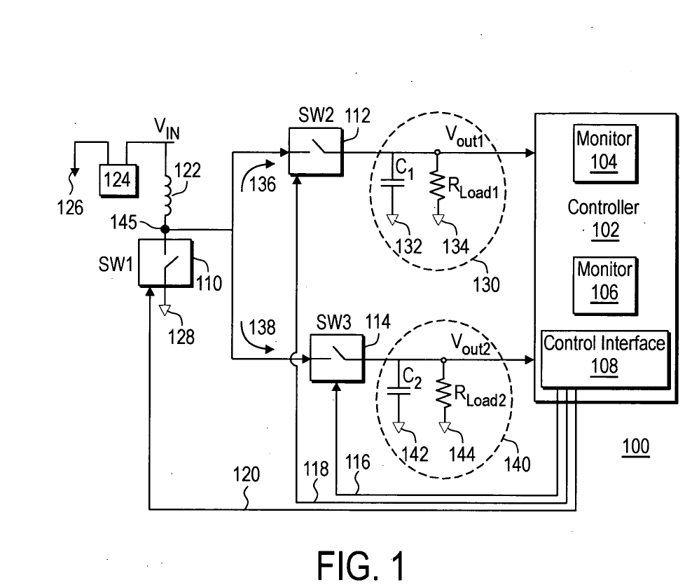

Referring to FIG. 1, one embodiment of the invention is illustrated in a configuration of a dual output switching regulator 100. The regulator 100 includes controller 102. The controller includes monitors 104 and 106 configured to monitor two output voltages, namely Vout1 and Vout2 in this example. The controller further includes a control interface 108 configured to control the switching of the three switches, 110, 112, and 114 with control lines 116, 118 and 120 configured to control the power switching operation. The circuit further includes inductor 122 that can be connected to a power source, such as a battery 124 connected at one end to ground 126 and at another end to the input Vᵢₙ, of inductor 122. In charging the inductor, switch 110 can be closed, grounding the inductor at ground 128, and closing the circuit from ground 126 to ground 128, allowing the battery 124 to charge the inductor 122.

For example, in operation of the regulator, switch 110 can be initially closed by the controller control line 120 to charge the inductor. In this mode, the voltage is transmitted to the inductor via the closed circuit between ground 126 and ground 128 as discussed above.

The inductor in this phase stores energy in the growing magnetic field and draws current from the power source 124, typically the battery cell. This first phase, wherein the inductor stores energy from the power source, ends with the opening of switch 110. The next phase begins with the closure of switch 112 by control line 118. This second phase of the operation transmits voltage into Vout1, the first output voltage channel as monitored by the controller 102. Monitor 104 is configured to monitor the voltage delivery of Vout1 continuously during operation. This second phase, the delivery of current to output channel Vout1 (shown within components 130), persists for a time determined by the controller 102 and will eventually end when switch 112 is opened. Therefore, the period during which energy is delivered to the output channel Vout1 is not continuous: at least some time during which other phases are active, channel Vout1 is not actively receiving energy stored in the field of the inductor. It is therefore necessary to filter the output channel Vout1 with filter circuit 130, capacitor C₁ tied to ground 132 and equivalent load resistance R_{Load1} tied to ground 134 are shown to indicate this. The filtering operation on Vout1 may be performed by various means as are known in the art.

A distinguising feature of this invention is the presence of one or more subsequent output channels, therefore there are at least two and possibly more output channels configured to receive the energy stored in the inductor. In this example, a subsequent channel to 136 is indicated as 138, each is configuerd with substantially similar components to output channel Vout1 (136). According to the invention, more than two outputs can be supported, one of which must be in Boost mode at any given time.

The first channel, just described, may operate first, and the circuit can subsequently switch to the second channel 138 for further operation. In this example a third phase, delivery of current to output channel Vout2 begins with the closure of switch 114 (at this time switch 112 is open since phase two has just terminated). The second channel 138 has Vout2 with filter circuit 140, capacitor C₂ tied to ground 142 and equivalent load resistance R_{Load2} tied to ground 144. Similarly to phase 2, this output channel Vout2 is monitored by 106 in controller 102. Therefore, this third phase persists for a time determined by controller 102. In this example only two output channels are present, and the next phase is the repeat of phase one, the loading of the inductor with energy from the battery cell.

In the most general terms, the invention provides the presence of additional output channels in addition to a single output channel of a conventional buck or boost regulator that is known in the art. These additional channels each have a desired output voltage/current configuration, commonly the output is required to hold a fixed voltage and deliver a variable current. Athough not a necessity, the controller 102 may be configured to hold a fixed current and deliver a variable voltage. These constraints, such that the individual outputs have a defined voltage/current chararacteristic, increase the complexity and the stability criteria of the controller. The invention provides one solution to the design of the controller for fixed output voltage variable output current applications.

According to the invention, a system of multiple outputs from a single inductor that is stable in the sense that the output conditions are met for an indefinite time with a bounded current through the inductor. According to the invention, the controller 102 will operate the switches 110, 112, 114 in this example such that the inductor current remains bounded. This may be achived by requiring that, for any fixed output load condition, the current through the inductor at the beginning of all phases (as defined for example, by the start of the inductor load phase, in this example when 110 is first closed) be substatially the same. In contrast, if the output load condition is not fixed (for example, if the output current changes in an output channel where the controller is configured to hold a fixed voltage at a variable load), then, over a number of cycles until a new equlibrium condition is reached, the inductor current at the start of the cycle will differ from cycle to cycle. This transient difference in inductor current only occurs while seeking a new equilibrium operating point.

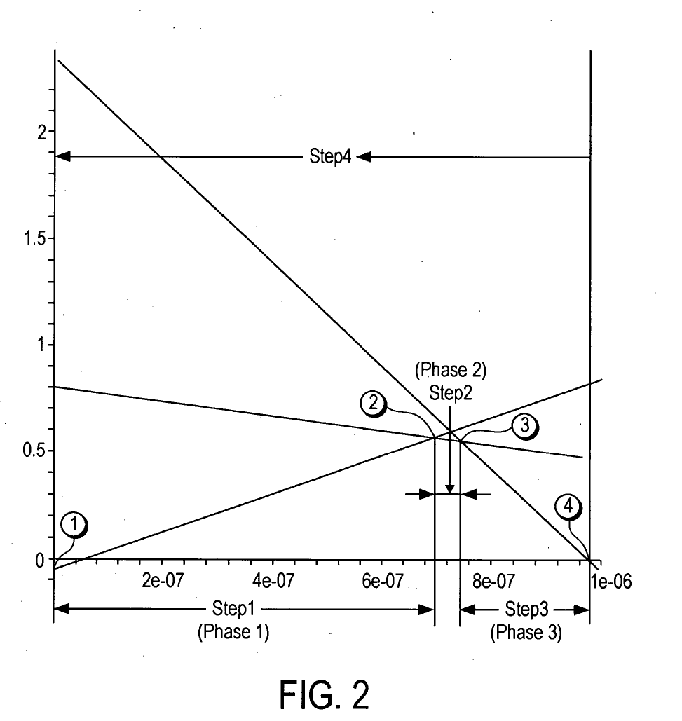

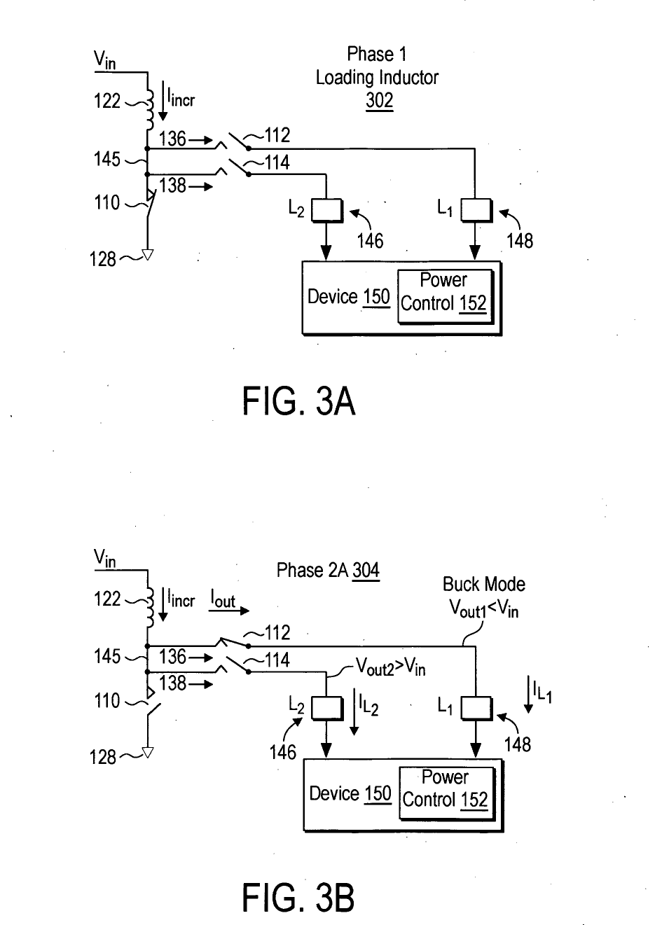

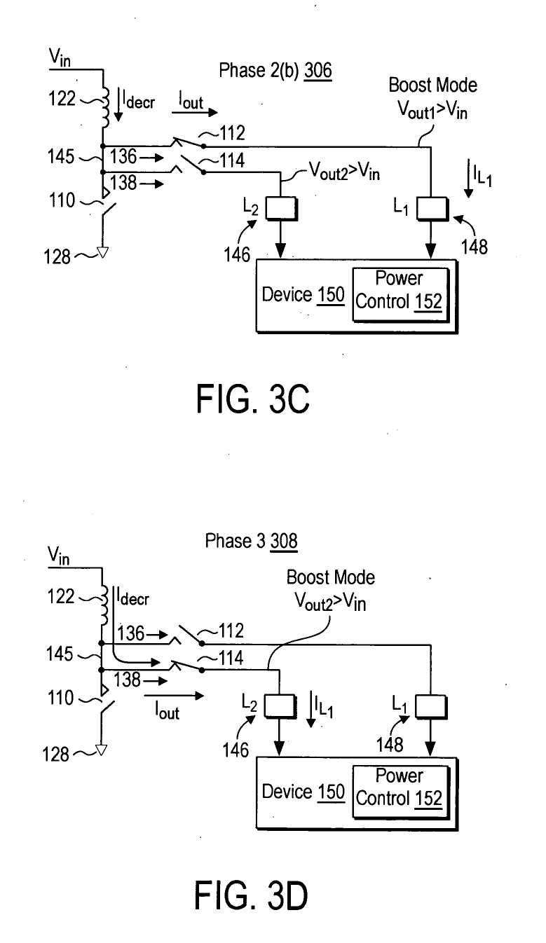

FIG. 2 shows the current through the inductor vs time. This is one embodiment that illustrates one timing configuration of the timing of controls of the three switches, S1, S2 and S3 (110, 112, 114 respectively in FIG. 1). The point indicated as (1) is the current flow at the start of a cycle, and points (2) and (3) are intermediate points indicating the different phases in the cycle: phases P1, P2 and P3. Point (4) is the start of the next cycle. According to the invention, in a preferred embodiment, the electrical current level at point (4) is constrained by the internal operation of the controller to be substantially the same as the current at point (1). Therefore, the the condition of a bounded current for indefinite time is met, and the cycle can repeat indefinitly. FIG. 2 shows three phases, the inductor load time in Step 1, the subsequet the connection to the first output channel (Vout1) P2 in Step 2, and the subsequent connection to the second output channel (Vout2) P3 in Step 3. However in general any number of phases of output P2. Pn may be employed. The degenerate case where only P1 and P2 exist (ie a single output channel is employed), which is known in the art. The actual switching configurations in the circuit are descibed below and illustrated in FIGS. 3A-3D.

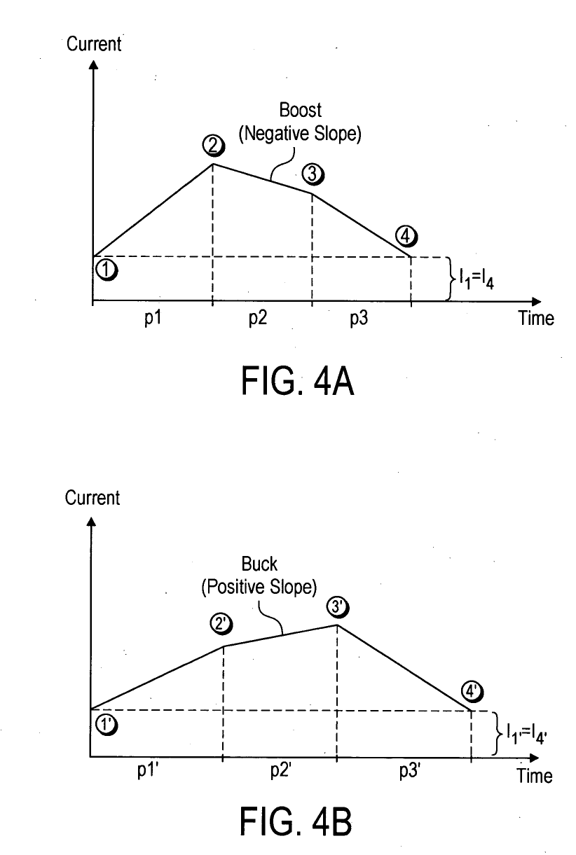

The steady state requirement of any switching regulator is that the average current in the inductor settles to some constant. This can be seen in the graph of FIG. 4. Note that the value of the inductor current is the same at the beginning of the cycle (time=0) as at the end of the cycle (Time=1e−6). Thus, when the process is repeated, the voltage values do not change. The output voltage is related to the slope of the lines in phases p2 and p3. The requirement for continuous steady-state operation is that the current at the end of the cycle equal the current at the start of the cycle. As shown in FIG. 4a this requirement can be met with a negative slope in phase 2, or, as shown in FIG. 4b this requirement can be met with a positive slope in phase 2. The slope of the phase 2 section is determined by the difference in voltage between the input voltage (Vin FIG. 1A) and the first output voltage (Vout1 FIG. 1A) if the slope is negative Vout1 is less than Vin and the output is in Buck mode, if the slope is positive Vout1 is greater than Vin and the output is in Boost mode. Since the circuit has the ability to have either both negative slopes (Boost, Boost), or one positive and one negative slope (Buck, Boost) and still be able to have the value of the current at the beginning of the cycle equal to the end of the cycle, this is how buck-boost is accomplished in the output Vout1.

Referring again to FIG. 2, the current in the inductor is illustrated over a complete cycle. (Steps 1-4 outlined above) In one particular example, for this FIG. 2, the parameters may be as follows

Vin=0.9 Volts (Battery)

Vout1=1.2 Volts (Boost Mode)

Vout2=3.3 Volts (Boost Mode)

RLoad1=50 Ohms

RLoad2=50 Ohms

Inductor=1 uH

Where Step 1 shows the charging of the inductor. Step 2 shows the discharging of the inductor into Vout1. And, Step 3 shows the discharging of the inductor into Vout2. Step 4 is simply a return to beginning of the process to Step 1.

The change in inductor current over the whole period is Zero, where the voltage is zero at the beginning of step 1, and back to zero at the end of step 3. Thus, when the cycle is repeated, the voltages are equal, and the transition from buck to boost is smooth, and the voltage delivered to the controller, whether from channel 1 or channel 2, is substantially constant.

The slope of the lines in FIG. 2 defines the output voltages. Since the slope of the Yellow line can be either increasing (which would mean it is in Buck mode), or decreasing (Boost mode) and the condition of the net change in current is zero can be satisfied (since the Green line can bring the current back to the same level as where it started at the beginning of Step 1) this shows how both Buck and Boost modes can occur on 1 output, and that the other output is in Boost mode. It is in Boost mode since the slope of the line of step 3 must always be negative in order to bring the inductor current back to where it was at the start of the cycle.

Referring to FIGS. 3A-3D, one embodiment of the invention is illustrated as a power switching circuit 300 in various states of operation. The circuit inculudes an input voltage Vin that is connected at one end to inductor 122, and at another end to a node 145 that interconnets the one end of the inductor to switches 110, 112 and 114. There are three phases in this embodiment, labeled 1, 2a, 2b and 3, where the two phases 2a and 2b are alternative phases for the second phase, where phase 2A is in buck mode (Vout1<Vin) and phase 2b is in boost mode (Vout1>Vin). As described below together with FIGS. 4A and 4B, these two phases correspond to the slope of the current. Corresponding to Phase 2B 306, FIG. 3C, the slope in phase p2 (between points 2 and 3 in FIG. 4A) is decreasing (negative slope) when in boost mode. Corresponding to Phase 2A 304, FIG. 3B, the slope in phase p2′ (between points 2′ and 3′ in FIG. 4B) is increasing (positive slope) when in buck mode.

Switch 110 is connected to ground, and, when closed, connnects the other end of the inductor to ground. Switch 112 is connected at one end to node 145, and at another end to a first load 146, or L₁. Switch 114 is connected at one end to node 145, and at another end to a first load 148, or L₂. The circuit 300 is connected to a device 150 having controller 152. Each switch, 110, 112 and 114 is controlled by a controller, such as power control 152. The controller can be any circuit that is programmed to detect voltage and/or current levels at certain points, open and close switches in response to such levels, and possibly to adapt to conditions whereby the switching between different circuit paths advanageously charges the inductor with the input voltage, Vin, and also delivers current from the inductor 122 to loads L₁ and L₂ in a manner that best utilizes the delivery of power to the loads. The loads L₁, L₂ are illustrated outside device 150, but may be part of or incorporated in device 150, and represent consumers of power transmitted from power source Vin via the inductor 122 when either of the switches 112, 114 are closed. Thus, the invention is directed to the efficient use of power delivered from a power source, Vin, to the individual loads and/or device 150, however power is consumed in a given device. For example, an MP3 player may have an internal load that consumes power delivered by circuit 300, where musical sounds are produced through a speaker headset, ear phones or other listening device. In another application, an MP3 player may have external speakers that separately consume power apart from the device. Those skilled in the art will appreciate that the utility of any circuit configured according to the invention will benefit from the novel and useful means to deliver power to a device, including subcomponents and other devices, and several similar circuits may be incorporated into a device or system to take advantage of such novel features.

In FIG. 3A, Phase 1 is illustrated 302, where switchs 112 and 114 are open, and switch 110 is closed to charge the inductor 122. This occurs while the switch 110 is closed, closing the circuit to apply Vin at one end of inductor 122, where the inductor is grounded at ground 128 through switch 110. This charging may occur over a predetermined period of time, or may be sensed by the device 150, perhaps via power control module 152. Those skilled in the art will understand that there are many ways to monitor, charge or otherwise utilize an inductor for use in delivery of power to a circuit or device. Once the inductor 122 is charged, then switch 110 is released. In operation, the inductor discharges current to either channel 136 or 138. In operation, the two load alternately receive load currents, back and forth as the loads require, under the control of controller 152.

In FIG. 3B, the next phase, indicated as Phase 2(a) 304 is illustrated. Switch 112 is closed, and switch 114 is opened, allowing current Iₒᵤₜ to flow through channel 136 and through load L₁ to produce I_{L1}, the current carried by the load L₁. The circuit is in buck mode in Phase 2(a), where the current through inductor 122 is increasing, I_{incr.}, and Vₒᵤₜ₁ is less than Vᵢₙ. The current continues to increase because the voltage across the inductor remains positive: the output Vout1 is less then Vin and so the current will continue to increase. The condition that the current at the start of the cycle must, in the steady state, equal the current at the end of the cycle can not be met without use of a third phase: the current increases in P1 and increases in P2—so at least one more phase during which the current in the inductor decreases will be required.

Referring to FIG. 3C, an alternative to Phase 2(a), Phase 2(b) 306 is illustrated. Phase 2(b) is similar to that of Phase 2(a), but the distinction between phase 2(a) and Phase 2(b) is that, the circuit is in boost mode in Phase 2(b), where the current through inductor 122 is decreasing, I_{decr.}, and Vₒᵤₜ₁ is greater than Vᵢₙ. The current Iₒᵤₜ flows through channel 136 via closed switch 112. Thus, the ability of the circuit 300 to deliver Iₒᵤₜ current to the load illustrates that the current of the inductor in Phase 2 can be either increasing or decreasing, depending on the circumstances of the circuit, such as whether the power source voltage is greater or less than that of the voltage delivered to either of the loads. The condition that the current at the start of the cycle must, in the steady state, equal the current at the end of the cycle can be met without use of a third phase: the current increases in P1 and decreases in P2, so some duration of P1 and P2 can be implemented where the currents at start and end are equal.

Referring to FIG. 3D, the circit 300 is illustrated in boost mode, with switch 110 open again, switch 112 is now open, and switch 114 is now closed. The current across the inductor 122 is decreasing, I_{decr.}, and the current Iₒᵤₜ flows through channel 138 via closed switch 114. Furthermore, Vₒᵤₜ₂ is greater than Vᵢₙ and so the current in the inductor is decreasing. This illustrates Phase 3, 308 (Step 3 of FIG. 2), the end of the three phases of the circuit. The process then repeats itself back at Phase 1, where the inductor recharges again.

It is the existience of the third phase wherein the current in the inductor is known to be decreasing (which is caused by the Vout2 voltage being greater than the Vin voltage) that allows the current at that start of the cycle to be the same as the current at the end of the cycle, independent of the current increasing or decreasing in phase 2. Therefore, the presence of at least one more channel operating in Boost mode is sufficient to allow a steady state condition of the circuit when one channel is either in buck or boost mode.

Referring to FIGS. 4A and 4B, two separate output signal samples of a two output channel example is illustrated. The invention, however, is extensibe to any number of output channels. Clearly, if the current at the end of the cycle is the same as the current at the beginning of the cycle, then any increase in current during P1 must be cancelled by a decrease in current during P2 and/or P3. In both FIGS. 4A an 4B, the increasing inductor current during P1 and P1′ is caused by the power source voltage, such as a battery providing a voltage, across the inductor. This concept is known according to the relation: dI/dt=V/L. The positive slope during P1 indicates that the voltage across the inductor is positive, which corresponds to the end labelled Vin from element 124 (FIG. 1A). This is consistant with the current being more positive than ground 128 (FIG. 1A) connected during P1 when switch 110 is closed). FIG. 4A shows a decreasing current during P2, this indicates that the voltage across the inductor is now negative and therefore Vout1 (which is connected by 112 durinn P2) is more positive than the Vin (commonly the battery voltage and indicated as Vin from element 124). Therefore, P2 is a boost phase in this diagram, where the output voltage is greater than the input voltage. Similarly, P3, when Vout2 is active via switch 114, also is a decreasing current phase and hence is also a boost phase having Vout2 greater than Vin.

A power switching circuit configured according to the invention may also operate while the circuit is in phase P2′ and is in a buck mode. This is illustrated in FIG. 4B. As can be seen, the current value at point (1′) is substantially the same at the current value at point (4′). Therefore, it has met the criteria of the current at the end of the cycle being the same as at the beginning. This allows the signal to repeat itself. The slope during P2 is however now positive, implying that the voltage across the inductor remains positive. Therefore, the output voltage during P2′ (ie vout1) must be lower than the battery voltage. As a result, the output during P2′ is now in buck mode.

In operation, the controller's voltage monitor 106 is configured to sense the voltage level at Vout2. If the monitor senses that the voltage level is at an acceptable level, the controller maintains the connection of the second channel 138.

According to the invention, any configuration where the current indicated at (1) or (1′) is substantially the same as at point (4) or (4′) will suffice to meet the bounded current requirement. Thus, any slope of the line that represents the current values, whether it has a positive, negative or substantially zero slope, during the P2 phase is adequate.

In a preferrend embodiment, at least one of the phases P1, P2 or P3 must be in boost mode, and each branch 136, 138 moves from buck, to buck/boost, to boost, back to buck, and so on. Thus, it alternates in the different modes. In a preferred embodiment, at least one of the branches is boost mode at any point in the process. Referring to FIGS. 4A and 4B, as discussed above, phase points P2 and P2′ corresponds with Phase 2(a) and 2(b) illustrated in FIGS. 3B and 3C respectively. According to the invention, in the operation of a diminishing power source, it is only during a boost mode output that the current can return back to the initial current. Thus, the other non-boost output can be either buck or boost and, furthermore, the other non-boost output can make a continuous change between buck and boost.

Those skilled in the art will understand that any controller topology can implement the required criteria, and many controllers exist that are capable of controlling the switches 110, 112, 114 to implement either of the two implementations illustrated in FIGS. 4A and 4B, to provide a single inductor regulator with at least two outputs, one of which exhibits a continuous transition between buck and boost.

Upon a change of modes, for example from buck to boost, the second channel 138 of the circuit is configured to be switched on by the controller if switch 112 is opened by control line 118 and switch 114 is closed by control line 116 to transmit voltage into Vout2, the second output voltage channel configured to deliver power from the inductor to the controller 102. The controller then delivers power to the controls and functions of the device just as it did for Vout1. Monitor 106 is configured to monitor the voltage delivery of Vout1 during operation. The resistance-capacitance (RC) circuit 140 includes capacitor 142 and load resistor 144 configured in parallel, where each is connected to ground on one end, and connected together at another end.

Once power is replenished, for example when a new battery is connected or a rechargeable battery is recharged, Switch 114 is opened by control line 116 and switch 110 closes again to charge the inductor, and to repeat the cycle. Generally, the system charges the inductor, then the controller opens and closes switches 112 and 114 alternately to load the two loads when needed. Those skilled in the art will understand that further and multiple loads can be added in a similar manner and loaded in a similar manner. The invention is directed to the ability to provide current from a power source to at least two loads from a single inductor.

The timing of the switching is controlled by the controller, and the exact timing depends the controller's response to the voltage levels sensed by the voltage monitors on all the operating conditions. The circuit can be thought of as more of a balancing act. The (voltage*time) across the inductor is the weight, so when the inductor it is grounded (switch 110, closed and the other 2 are open) the voltage across the inductor is the battery voltage. And this voltage can be considered to be put on one side of the balance beam scale. On the other side of the balance scale is the sum of the V*t1 for Vout1 and V*t2 of Vout2, where V is the voltage across the inductor and t1 is the time at which switch 112 is on, and t2 is the time switch 114 is on. If both channels are in boost mode, both channels have “weight”. If one channel is in Buck mode, it can be understood as having negative “weight”, thus canceling out some of the Boost modes “weight”. This is why 1 of the modes must always be boost, it must either be added to the other channels “weight” (which again is represented by the V*t product) to cancel out the “weight” that the battery supplies on the other side of the balance beam. This is one way of explaining how the battery voltage is used up.

The timing of when switches 110, 112 and 114 are opened and closed is determined by the control such that the dual output switching regulator will hold the Vout1, and Vout2 at some predetermined values. Again, in a preferred embodiment, one of the two outputs remains in boost mode at all times, where the other output is free to perform in either buck or boost mode.

Referring to FIG. 5, an operational and diagrammatical flow chart is illustrated. Again, the operation of the switches is controlled by the controller of the device that is utilizing the power source. The switching circuit is a mechanism used by the controller to effectuate the buck and boost modes when appropriate for a particular operation. Regarding the timing operation of switch 1, S1 110, the switch is closed in the initial phase 502, where the inductor is charging p where the switch is closed at the time interval, the end of Step 1, FIG. 2, and the switch is closed at the falling edge 508. During the periods of Steps 2 and 3, the switch S1 remains open, until the next process begins at the end of Step 3, where S1 opens again at timing edge 520. Referring to the timing diagram of switch 2, S2 112, this switch remains open during the charging phase of the inductor, Step 1, and closes at the timing edge 510, which is the beginning of Step 2. S2 remains closed during the time period 518, or Step 2, then closes at timing edge 516. During this period, a current load is dumped to the corresponding load L1. S2 remains closed 522 until the next cycle of steps. Referring to the timing diagram for switch 3, S3 114, S3 remains open during Steps 1 and 2, and closes at timing edge 519, and remains closed throughout Step 3. During this period, a current load is dumped from the inductor to the load L2. S3 opens at the beginning of a new cycle at timing edge 524. According to the invention, these steps can be repeated over and over in a manner that best utilizes the switching circuit to deliver a current from a source, such as from a battery or other source, in an efficient manner. Referring again to FIG. 2, and also with respect to the timing diagrams of FIG. 5, many different configurations of timing under the control of the processor are possible, but one preferred embodiment is illustrated here to help describe the invention.

The invention has been described in the context of a system and method for operating a dual output switching regulator. It will be understood by those skilled in the art that many different applications are possible without departing from the spirit and scope of the invention, as is defined by the appended claims and their equivalents.

1. A power switching circuit comprising:
a switching circuit configured to connect an inductor to at least two output channels;
a monitoring circuit configured to monitor at least one of the output channels and to respond to the output characteristic of the channel; and
a controller configured to receive an input signal from the monitoring circuit and to adjust the relative timing of the switch elements, such that the desired output characteristic on at least one of the output channels is maintained.

2. A power switching circuit as in claim 1 wherein the monitored output characteristic is a nominally fixed voltage and the current is allowed to vary in response to the load condition of the monitored channel.

3. A power switching circuit as in claim 1 wherein the monitored output characteristic is a nominally fixed current and the voltage is allowed to vary in response to the load condition of the monitored channel.

4. A power switching circuit as in claim 1 wherein the monitored output characteristic of at least one channel is a nominally fixed current and the voltage is allowed to vary in response to the load condition of the monitored channel; And
the monitored output characteristic of at least one channel is a nominally fixed current and the voltage is allowed to vary in response to the load condition of the monitored channel.

5. A power switching circuit as in claim 1 wherein all of the output channels operate with a nominally higher output voltage than the voltage derived from the input source in boost mode.

6. A power switching circuit as in claim 1 wherein at least one of the output channels operates with a nominally higher output voltage than the voltage derived from the input source; and
at least one of the channels operates with a nominally lower output voltage than the voltage derived from the input source.

7. A power switching circuit as in claim 1 wherein at least one of the output channels operates with a higher output voltage than the voltage derived from the input source; and
at least one of the channels operates in either buck or boost mode as determined by a modification to the control loop in response to an external control signal to adjust to a new operating point as measured by the monitoring circuit when a change in output voltage on the one channel is desirable.

8. A power switching circuit as in claim 1 wherein at least one of the output channels operates with a higher output voltage than the voltage derived from the input source, boost mode; wherein at least one of the channels operates in either buck or boost mode as determined by a modification to the input voltage derived from the input source, where the input source voltage is variable and the at least one channel output voltage is fixed.

9. A power switching circuit comprising:
a charging switch configured to be connected to an inductor at one node and configured to receive control signals to open and close the charging switch;
a first channel coupled to the one node with a first channel switch, configured to supply a first channel voltage, configured to operate in one of buck mode and boost mode and configured to receive control signals to open and close the first channel switch; and
a second channel coupled to the one node with a second channel switch, configured to supply a second channel voltage, configured to operate in one of buck mode and boost mode and configured to receive control signals to open and close the first channel switch.

10. A power switching circuit according to claim 9, further comprising a controller having a monitoring circuit configured to monitor the value of the output voltage of a voltage source and to transmit control signals to the charging switch, the first channel switch and the second channel switch.

11. A power switching circuit according to claim 9, further comprising an inductor connected to the one node at one end and connectable to an input voltage source at another end, where the charging switch is connected to a controller at another end and configured to close in response to a controller signal in a charge mode to charge an inductor.

12. A power switching circuit according to claim 9, wherein at least one channel configured to supply a voltage value to a controller

13. A power switching circuit according to claim 9, further comprising a controller configured to monitor the voltage levels at either switch to control the charging of an inductor and to switch either the first or second channel switch in buck or boost mode.

14. A power switching circuit according to claim 9, wherein at least one channel is in boost mode.

15. A power switching circuit according to claim 9 configured to supply each channel voltage value to a controller, controller sends control signals to each of the switches to enable one of the charging of the inductor and delivery of current to at least one channel.

16. A power switching circuit according to claim 9, further comprising an inductor configured to receive a charge from a power source, wherein the first and second channel switches are controlled by a controller configured to supply at least one channel voltage value by closing at least one of the first and second channel switches.

17. A method of supplying power with a switching circuit, comprising:
charging an inductor from a power source; and
alternately releasing current from the inductor to one load by closing one switch and releasing current from the inductor to another load by closing another switch while substantially simultaneously opening the one switch.

18. A method according to claim 17, wherein alternately releasing current from the inductor from one switch to another switch includes releasing current to at least one switch while current released from the inductor is decreasing.

19. A method according to claim 17, wherein alternately releasing current from the inductor from one switch to another switch occurs in separate phases and includes releasing current during at least one phase while current released from the inductor is decreasing.

20. A method according to claim 17, further comprising alternately releasing current from the inductor to one of a plurality of loads by closing a switch associated with one load while any switches associated with other loads are open and releasing current from the inductor to another load by closing another switch while substantially simultaneously opening a previously closed switch.

21. A method according to claim 20, wherein alternately releasing current from the inductor via one switch to another switch occurs in separate phases and includes releasing current during at least one phase while current released from the inductor is decreasing.

22. A system of supplying power with a switching circuit, comprising:
means charging an inductor from a power source; and
means for alternately releasing current from the inductor to one load including means for closing one switch and releasing current from the inductor to another load by closing another switch while substantially simultaneously opening the one switch.

23. A system according to claim 22, wherein the means for alternately releasing current from the inductor from one switch to another switch includes means for releasing current to at least one switch while current released from the inductor is decreasing.

24. A system according to claim 22, wherein the means for alternately releasing current from the inductor from one switch to another switch operates in separate phases and includes means for releasing current during at least one phase while current released from the inductor is decreasing.

25. A system according to claim 17, further comprising means alternately releasing current from an inductor to one of a plurality of loads including means for closing a switch associated with one load while any switches associated with other loads are open and means for releasing current from the inductor to another load by closing another switch while substantially simultaneously opening a previously closed switch.

26. A system according to claim 25, wherein the means alternately releasing current from the inductor via one switch to another switch occurs in separate phases and includes means for releasing current during at least one phase while current released from the inductor is decreasing.
